(19) United States
(12) Patent Application Publication
(10) Pub. No.: US 2014/0263056 A1
(43) Pub. Date: Sep. 18, 2014

(54) PROCESS FOR WATER TREATMENT PRIOR TO REVERSE OSMOSIS

(71) Applicant: Veolia Water Solutions & Technologies North America, Inc., Moon Township, PA (US)

(72) Inventors: Stanton R. Smith, Belmont, MA (US); Jeremy Cardin, Belmont, MA (US); Benoit Tranape, Somerville, MA (US); Richard Higgins, Reading, MA (US)

(73) Assignee: Veolia Water Solutions & Technologies North America, Inc., Moon Township, PA (US)

(21) Appl. No.: 14/205,464

(22) Filed: Mar. 12, 2014

Related U.S. Application Data
(60) Provisional application No. 61/784,553, filed on Mar. 14, 2013.

(51) Int. Cl. C02F 1/44; C02F 1/52

(52) U.S. Cl. CPC C02F 1/441; C02F 1/5245
USPC 210/638

(57) ABSTRACT

A process for treating feedwater with a microfiltration or ultrafiltration membrane unit and a downstream reverse osmosis unit. An aluminum salt coagulant is added to the feedwater upstream of a membrane separation unit. The aluminum salt coagulant is mixed upstream of the membrane separation unit. A sufficient amount of the aluminum salt coagulant is mixed with the feedwater for a sufficient residence time to control the concentration of the aluminum in the permeate emitted by the membrane separation unit.

Applicant claims priority based on U.S. Provisional Patent Application No. 61/784,553 filed Mar. 14, 2013. The subject matter of this application in incorporated herein by reference.

### FIELD OF THE INVENTION

The present invention relates to a pre-treatment process for removing aluminum from a feedwater directed to a reverse osmosis unit.

### BACKGROUND OF THE INVENTION

Reverse osmosis (RO) is employed as a key step in production of municipal drinking water and for treatment of various industrial wastewaters to a quality suitable for re-use and/or environmental discharge. Productivity (measured as permeability or pressure-normalized flux) of commercial RO processes is dependent on minimizing concentrations of RO-membrane foulants in the feedwater to the RO process. A common RO-membrane foulant is dissolved aluminum ion, which can be present in the starting water to be treated and/or may be released into RO feedwater by useful pretreatment processes that utilize aluminum salts as coagulants to remove dissolved organics present in the starting water. RO processes require RO feedwater to contain no more than about 0.1 ppm dissolved aluminum to minimize the RO membrane fouling effect by the aluminum ions. Water treatment processes that utilize aluminum salt-based coagulation prior to an RO membrane process operation generally utilize membrane microfiltration or ultrafiltration as a pre-treatment step to remove suspended solids and to coagulate and/or flocculate some fraction of dissolved organics in the process water, such that the permeate from the membrane microfiltration or ultrafiltration process becomes the feedwater to the RO process. For such integrated processes, it has generally been necessary to provide a pH-modifying additive coincident with aluminum salt coagulation in order to ensure that the aluminum concentration in the RO feedwater is maintained below the 0.1 ppm level. Use of the pH-modifying additive adds cost and complexity to the integrated process.

Coagulation and/or flocculation of dissolved and suspended compounds in process streams just prior to membrane microfiltration or ultrafiltration is well-known in the field of water treatment.¹ The most commonly employed coagulant and flocculant aids include organic polymeric compounds, iron salts and aluminum salts. Specific choice of coagulant/flocculant for a particular process stream is based on consideration of relative cost, relative effectiveness of effectively coagulating/flocculating compounds in the process stream, and degree of permeability of the captured filter cake on the microfiltration/ultrafiltration membrane surface. For instance, for clarification of tailings pond water derived from oil sands mining, membrane ultrafiltration can be employed, with aluminum sulfate (alum) known to be a preferred coagulant due to high solids removal efficiency.² Similarly, alum coagulation prior to ceramic membrane ultrafiltration is known.³ ¹ Water Treatment: Principles and Design, Second Ed. rev. by J. C. Crittenden et al., Wiley & Sons, Hoboken, N.J., 2005, p. 1012.² E. S. Kim et al., Sep. Purif. Techn, 81 (2011) 418-428.³ K. Guerra et al., Sep. Purif. Techn, 87 (2012) 47-53.

Additional considerations may be other process effects characteristic of specific coagulants/flocculants, such as relative ease of removal from the membrane surface, and effects on downstream processes. A specific instance of a deleterious effect on a downstream process is the effect of residual aluminum salt solubility on downstream reverse osmosis (RO) membranes, for which dissolved aluminum cations can cause strong fouling of the RO membrane. Hence, for integrated water treatment processes involving coagulation/flocculation combined with membrane microfiltration or ultrafiltration, followed by an RO step to produce high-purity water, generally use of aluminum salts as coagulants would be avoided due to the side-effect of RO membrane fouling. While it is possible to add a pH-modifying additive coincident with, or immediately after, aluminum salt coagulation, this introduces added cost and process complexity. Other practical means of mitigating fouling of RO membranes by dissolved aluminum ions derived from upstream aluminum salt coagulation processes have not been considered in the prior art. The subject of this invention is such a process.

### SUMMARY OF THE INVENTION

In one embodiment, the present invention entails a process for treating feedwater with a microfiltration or ultrafiltration membrane separation unit and a downstream reverse osmosis unit. A coagulant in the form of an aluminum salt is added to the feedwater upstream of the membrane separation unit. This increases dissolved aluminum concentration in the feedwater and has the potential to foul membranes of the RO unit. To address this problem, the process in one embodiment, without any significant pH adjustment from addition of additional pH-modifying compound(s), reduces the aluminum concentration in the feed to the RO unit to less than 0.1 ppm by controlling the hydraulic residence time of the coagulated feedwater between the time of adding the aluminum salt coagulant and the time the feedwater is discharged by the membrane separation unit as permeate.

In one embodiment, the hydraulic residence time between initiating coagulation and the discharge of wastewater, as permeate, from the membrane separation unit is less than 25 minutes.

### BRIEF DESCRIPTION OF THE DRAWINGS

FIG. 1 is a schematic illustration of the process of the present invention.

FIG. 2 is another schematic illustration of a particular embodiment of the present invention.

### DESCRIPTION OF EXEMPLARY EMBODIMENTS

With respect to the drawings, the wastewater treatment process of the present invention is shown therein and indicated generally by the numeral 10. As will be appreciated from subsequent portions of the disclosure, the wastewater treatment process adds an aluminum salt as a coagulant to the wastewater. The purpose of the aluminum salt is to destabilize particles in the wastewater to bring about aggregation and flocculation of these particles. In other words, the coagulant, which in this case is an aluminum salt facilitates the downstream removal of suspended solids and precipitants.

After the aluminum salt coagulant is added and thoroughly mixed with the wastewater, the wastewater is directed to a microfiltration or ultrafiltration membrane separation unit indicated by the numeral 12. Microfiltration or ultrafiltration membrane separation unit can be of various forms. In one embodiment, the membrane separation unit 12 is a ceramic membrane and, more particularly, a ceramic membrane of the cross-flow ultrafiltration type. In one example, the separation layer comprises titanium dioxide and has an average pore size of 0.01 microns. In another example, the separation layer comprises titanium dioxide and has an average pore size of 0.1 microns. As noted above, other types of microfiltration or ultrafiltration membrane separation units can be employed in the wastewater treatment process.

Ceramic membrane 12 produces a permeate stream and a retentate or reject stream. The ceramic membrane is operative to remove substantially all suspended particles and precipitants. The ceramic membrane can be utilized in a wide range of application to remove suspended solids and precipitants. In particular, the ceramic membrane is effective in treating produced water resulting from oil and gas recovery processes. Typically these waste streams include free oil and emulsified oil. The ceramic membrane is effective to remove both free oil and emulsified oil from the feedwater.

Continuing to refer to the drawings, downstream of the ceramic membrane 12 is a reverse osmosis unit 14. In this process, the reverse osmosis unit 14 is operative to receive the permeate produced by the membrane separation unit or ceramic membrane 12. Reverse osmosis unit 14 produces an RO permeate and an RO reject stream. The reverse osmosis units remove dissolved solids such as total organic carbon, soluble silica and a wide variety of dissolved solids.

As noted above, the process of the present invention entails mixing an aluminum salt coagulant with the wastewater upstream of the membrane separation unit 12 to destabilize particles in the wastewater and promote aggregation and flocculation of these particles. This process conditions the wastewater upstream of the membrane separation unit 12 such that suspended particles and precipitants can be easily removed in the membrane separation unit or ceramic membrane 12.

As shown in FIG. 1, an aluminum salt is added as a coagulant and is stirred and mixed in a reactor (reaction volume). In one example, the addition of an aluminum salt coagulant to the wastewater adds approximately 8 ppm of dissolved aluminum to the wastewater. While this is important for the purpose of removing solids from the wastewater, this relatively high aluminum concentration in the wastewater is a problem if it remains in the wastewater downstream of the ceramic membrane 12 and enters the reverse osmosis unit 14. This is because significant aluminum concentrations will foul and damage the membranes of the reverse osmosis unit 14. Thus, the process of the present invention removes aluminum from the wastewater prior to entry into the reverse osmosis unit 14.

It should be noted that some wastewater will contain significant concentrations of aluminum, concentrations above 0.1 ppm. The present process is also applicable to these wastewaters.

Therefore, the concern in the case of the embodiments illustrated herein is with the aluminum concentration in the permeate stream from the membrane separation unit 12. In order to avoid significant aluminum fouling of the reverse osmosis unit 14, it has been determined that the aluminum concentration from the permeate stream of the membrane separation unit 12 should, in one embodiment, be less than 0.1 ppm. It has been determined that the aluminum concentration in the permeate stream of the membrane separation unit 12 can be controlled by controlling the residence time or sometimes referred to as hydraulic residence time of the coagulated wastewater. In this case, we define hydraulic residence time as the time-averaged permeate flow rate through the membrane divided by the combined volume of wastewater in the membrane separation retentate loop, in the coagulant dosing reactor, and in any intermediate tankage and/or piping between the coagulant dosing reactor and membrane separation retentate loop divided by the time-average permeate flow rate through the membrane. The problem with a long residence time for the salt in the concentrate loop (equivalent to residence time of coagulated wastewater) is due to the following: immediate dissolution of the salt occurs with commensurate lowering of the feed/concentrate pH to a level that causes the majority of the aluminum to become immediately insoluble—this aluminum forms hydroxide precipitates/coagulants, which are captured on the ceramic membrane and thereby not released into the permeate. Over long residence times, i.e., greater than 20 to 30 minutes, the pH of the feed/concentrate rises due to on-going hydration reactions and this elevation in pH causes some of the captured insoluble aluminum to again become soluble, such that it is released into the permeate. It should be noted that, in one embodiment, no pH modifying additive is used in conjunction with the coagulant. That is, the process does not use any pH adjusting chemical treatment to reduce the concentration of aluminum in the feedwater to the RO unit. More specifically, the coagulated residence time is defined as the time between mixing the aluminum salt with the wastewater and the time that the permeate is discharged from the membrane separation unit 12. Specifically, it has been determined that this coagulated residence time should be less than about 20-25 minutes, or, in some embodiments, less than 30 minutes. Thus, the present invention entails a system and process that specifically controls the time between mixing the aluminum salt coagulant with the wastewater and discharging the permeate from the membrane separation unit 12. This is controlled by the particular configuration of the system components and the flow rate of the wastewater between the reactor where coagulation is initiated and the membrane separation unit 12.

### Example

Process water was taken from an oil sands mining tailings pond and trucked to a laboratory for use in pilot process test trials. This water had a pH of 8.16 and contained a dissolved aluminum concentration of 0.39 ppm and a total (dissolved plus suspended) aluminum concentration of 3.5 ppm. A concentrated solution was prepared using aluminum sulfate dodecahydrate (“alum”), which was dosed with rapid stirring into the process water at a ratio that produced an added dissolved aluminum concentration of 8 ppm in the process water. The alum-dosed process water was sent as feedwater to a ceramic crossflow ultrafiltration membrane (0.1 μm pore size, titanium dioxide separation layer) and separated into a permeate stream and concentrate stream. The permeate pH, membrane concentrate pH, and dissolved aluminum concentration were monitored as a function of residence time, defined as the time interval between introduction of the concentrated alum solution into the starting process water and removal of permeate from the ceramic ultrafiltration membrane. Table I provides these values as a function of residence time in the pilot process trials. These data show that dissolved aluminum concentrations below the value of 0.1 ppm are obtained for residence times less than about 20 to 25 minutes.

TABLE I

| Residence Time | | | Al Concentration in |
|---|---|---|---|
| (min.) | Concentrate pH | Permeate pH | Permeate (mg/L) |
| Before dose | 8.16 | N/A | N/A |
| 0.33 | 7.32 | 7.64 | 0.039 |
| 0.67 | 7.30 | 7.60 | 0.027 |
| 1.08 | NM | 7.58 | 0.076 |
| 1.77 | NM | 7.59 | 0.042 |
| 2.5 | NM | 7.64 | 0.055 |
| 3 | NM | 7.59 | 0.013 |
| 3.17 | 7.34 | 7.64 | 0.035 |
| 5 | 7.36 | NM | NM |
| 6 | NM | 7.71 | 0.028 |
| 10 | 7.43 | NM | NM |
| 12 | NM | 7.79 | 0.026 |
| 15 | 7.51 | NM | NM |
| 20 | 7.56 | NM | NM |
| 30 | NM | 8.02 | 0.112 |
| 60 | NM | 8.25 | 0.231 |

Turning to FIG. 2 and another embodiment of the present invention, it is seen that the process water or the wastewater being treated is directed to a stirred reaction tank or a reactor. In this case, for example, aluminum sulfate hydrate (alum) is added to the wastewater. It is stirred and mixed in the reaction tank and the total aluminum concentration in the wastewater in the reaction tank is, in one example, 1-12 ppm. The wastewater in the reaction tank is pumped to the ceramic membrane 12. The ceramic membrane produces a retentate which is referred to in FIG. 2 as membrane concentrate. The membrane concentrate is directed to a solids separation process, such as a filter press, where the solids are separated from the membrane concentrate. The clarified wastewater produced by the solids separation process is recycled to the mainstream, ahead of the point where the aluminum salt is added.

The ceramic membrane also produces a permeate which is referred to as product water. As discussed above, the product water or permeate produced by the ceramic membrane 12 is substantially free of suspended solids. In this case, the aluminum concentration in the product water or permeate stream produced by the ceramic membrane is less than 0.1 ppm in some embodiments and less than 0.12 ppm in other embodiments. This is because the system and process is controlled such that the time between mixing the aluminum sulfate hydrate and the time that the permeate stream emerges from the ceramic membrane 12 is less than about 20-25 minutes. In other embodiments, the system and process is controlled such that the time between mixing the aluminum sulfate hydrate or the aluminum salt coagulant and the time that the permeate stream emerges from the membrane separation unit or the ceramic membrane is less than 30 minutes.

Product water or permeate from the ceramic membrane is directed to the reverse osmosis unit 14 which produces a reject stream (RO concentrate) and an RO product water which is an RO permeate stream. Reverse osmosis unit 14 removes a wide array of dissolved solids from the wastewater treatment stream.

Details of the ceramic membrane discussed herein are not dealt with herein because such is not per se material to the present invention, and further, ceramic membranes are known in the art. For a review of general ceramic membrane technology, one is referred to the disclosures found in U.S. Pat. Nos. 6,165,553 and 5,611,931, the contents of which are expressly incorporated herein by reference. These ceramic membranes, useful in the processes disclosed herein, can be of various types. In some cases the ceramic membrane may be of the type that produces both a permeate stream and a reject stream. On the other hand, the ceramic membranes may be of the dead head type, which only produces a permeate stream and from time-to-time the retentate is backflushed or otherwise removed from the membrane.

The structure and materials of ceramic membranes as well as the flow characteristics of ceramic membranes varies. When ceramic membranes are used to purify produced water, the ceramic membranes are designed to withstand relatively high temperatures as it is not uncommon for the produced water being filtered by the ceramic membranes to have a temperature of approximately 90° C. or higher.

Ceramic membranes normally have an asymmetrical structure composed of at least two, mostly three, different porosity levels. Indeed, before applying the active, microporous top layer, an intermediate layer is formed with a pore size between that of the support and a microfiltration separation layer. The macroporous support ensures the mechanical resistance of the filter.

Ceramic membranes are often formed into an asymmetric, multi-channel element. These elements are grouped together in housings, and these membrane modules can withstand high temperatures, extreme acidity or alkalinity and high operating pressures, making them suitable for many applications where polymeric and other inorganic membranes cannot be used. Several membrane pore sizes are available to suit specific filtration needs covering microfiltration and ultrafiltration ranges.

Ceramic membranes today run the gamut of materials (from alpha alumina to zircon). The most common membranes are made of Al, Si, Ti or Zr oxides, with Ti and Zr oxides being more stable than Al or Si oxides. In some less frequent cases, Sn or Hf are used as base elements. Each oxide has a different surface charge in solution. Other membranes can be composed of mixed oxides of two of the previous elements, or are established by some additional compounds present in minor concentration. Low fouling polymeric coatings for ceramic membranes are also available.

Ceramic membranes are typically operated in the cross flow filtration mode. This mode has the benefit of maintaining a high filtration rate for membrane filters compared with the direct flow filtration mode of conventional filters. Cross flow filtration is a continuous process in which the feed stream flows parallel (tangential) to the membrane filtration surface and generates two outgoing streams.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of treating a feedwater with a reverse osmosis (RO) membrane and reducing the tendency of the RO membrane to foul due to aluminum in the feedwater or added as a part of pre-treatment, the method comprising:
mixing an aluminum salt coagulant with the feedwater and precipitating aluminum hydroxide-based precipitants from the feedwater;
after mixing the aluminum salt coagulant with the feedwater, directing the feedwater to a microfiltration or ultrafiltration membrane separation unit and producing a permeate stream and a reject stream where the reject stream includes the aluminum hydroxide-based precipitants;
wherein mixing the aluminum salt coagulant upstream of the microfiltration or ultrafiltration membrane separation unit includes mixing a sufficient amount of the aluminum salt coagulant with the feedwater for a sufficient residence time to control the concentration of aluminum in the permeate stream such that generally the aluminum concentration in the permeate stream is less than 0.1 ppm; and
directing the permeate stream to the RO membrane and filtering the permeate stream to produce an RO permeate stream and an RO reject stream.

2. The method of claim 1 wherein other than the mixing of the aluminum salt coagulant with the feedwater, the method performed upstream of the microfiltration or ultrafiltration membrane separation unit is performed in the absence of a pH adjustment.

3. The method of claim 1 including mixing aluminum sulfate with the feedwater upstream of the microfiltration or ultrafiltration membrane separation unit.

4. The method of claim 1 wherein the microfiltration or ultrafiltration membrane separation unit comprises a ceramic membrane.

5. The method of claim 1 wherein the hydraulic residence time of the aluminum salt coagulant in the feedwater prior to the microfiltration or ultrafiltration membrane separation unit is approximately 5 seconds to approximately 25 minutes.

6. The method of claim 1 including controlling the pH of the feedwater upstream of the microfiltration or ultrafiltration membrane separation unit to less than 7.8.

7. The method of claim 2 including adding aluminum sulfate to the feedwater upstream of the microfiltration or ultrafiltration membrane separation unit such that the aluminum sulfate concentration is in the range of 1 ppm to 12 ppm.

8. The method of claim 1 wherein there is no pH adjustment made to the wastewater prior to the wastewater entering the membrane separation unit.

9. The method of claim 1 wherein no pH modifying additive is used in conjunction with the aluminum salt coagulant.

10. A method of treating feedwater with a reverse osmosis (RO) membrane and reducing the tendency of the RO membrane to foul due to aluminum in the feedwater or added as a part of pre-treatment, the method comprising:
mixing an aluminum salt coagulant with the feedwater and precipitating aluminum hydroxide-based precipitants from the feedwater;
after mixing the aluminum salt coagulant with the feedwater, removing the aluminum hydroxide-based precipitants from the feedwater by directing the feedwater and aluminum hydroxide-based precipitants through a ceramic membrane and producing a permeate stream and a reject stream where the reject stream includes the aluminum hydroxide-based precipitants;
controlling the concentration of aluminum in the permeate stream from the ceramic membrane by mixing the aluminum salt coagulant with the feedwater for a residence time of 30 minutes or less and controlling the concentration of the aluminum in the permeate stream such that the aluminum concentration in the permeate stream is 0.12 ppm or less; and
directing the permeate stream to the RO membrane filtering the permeate stream to produce an RO permeate stream and an RO reject stream.

11. The method of claim 10 wherein, other than the mixing of the aluminum salt coagulant with the feedwater, the method performed upstream of the ceramic membrane is performed in the absence of a pH adjustment.

12. The method of claim 10 including mixing aluminum sulfate with the feedwater upstream of the ceramic membrane.

13. The method of claim 10 including controlling the hydraulic residence time of the aluminum salt in the feedwater prior to the feedwater reaching the ceramic membrane to approximately 5 seconds to approximately 25 minutes.

14. The method of claim 10 including controlling the aluminum concentration in the feedwater upstream of the ceramic membrane to approximately 1 to approximately 12 ppm.

15. The method of claim 10 wherein the feedwater comprises produced water having free oil and emulsified oil and the method includes removing the free oil and emulsified oil from the produced water in the ceramic membrane.

16. The method of claim 10 controlling the concentration of aluminum in the permeate stream by controlling the time between mixing the aluminum salt coagulant with the feedwater and the discharging of the permeate from the ceramic membrane.

17. The method of claim 10 wherein the aluminum salt coagulant is mixed with the feedwater in a reactor and the method includes controlling the flow rate of the feedwater between the reactor and the ceramic membrane such that the aluminum concentration in the permeate stream is 0.12 ppm or less.

18. The method of claim 10 including controlling the time interval between introduction of the aluminum salt coagulant into the feedwater and the removal of the permeate from the ceramic membrane.

19. The method of claim 1 wherein the aluminum salt coagulant is mixed with the feedwater in a reactor and the method includes controlling the flow rate of the feedwater from the reactor to the membrane separation unit such that the aluminum concentration in the permeate stream is less than 0.1 ppm.

20. The method of claim 1 further including controlling the time interval between introduction of the aluminum salt coagulant into the feedwater and the removal of the permeate from the membrane separation unit such that the aluminum concentration in the permeate stream from the membrane separation unit is 0.1 ppm.

21. The method of claim 10 wherein the feedwater comprises oil sands mining wastewater having free oil and emulsified oil and the method includes removing the free oil and emulsified oil from the produced water in the ceramic membrane.
